(19) United States
(12) Patent Application Publication
(10) Pub. No.: US 2016/0281382 A1
(43) Pub. Date: Sep. 29, 2016

(54) Extreme Weather Protection Shelter

(71) Applicant: Oliver James Groves, Freeland, WA (US)

(72) Inventor: Oliver James Groves, Freeland, WA (US)

(21) Appl. No.: 15/173,716

(22) Filed: Jun. 6, 2016

(51) Int. Cl. E04H 9/14; E04B 1/94; B66F 3/46; E04H 9/16

(52) U.S. Cl. CPC E04H 9/145; E04H 9/16; E04B 1/941; B66F 3/46

(57) ABSTRACT

A weather protection system designed to protect people and buildings during meteorological events such as a tornado by retracting and securing a building above the ground.

### TECHNICAL FIELD

The present invention relates to the field of shelters. More particularly, the present invention relates to above-ground shelters which either can be installed in new construction or can be retrofit and would provide substantially more protection for people, possessions, and homes from disasters, such as forest fires, river flooding, mud slides, most earthquakes, tsunami, tornados, and hurricanes than current available options.

### BACKGROUND OF THE INVENTION

Tornados, Hurricanes and other extreme weather scenarios are dangerous meteorological events that can occur anywhere in North America and have been observed on all continents, except Antarctica. These storms can be devastating to life and property. While efforts have been made to improve detection, nothing like the detection systems available for hurricanes, which allow people to evacuate dangerous areas, exists. Often people have merely minutes of warning. This means that when a tornado, hurricane, or other wind storm occurs, people must utilize the structures available to them. This is especially true in the so-called Tornado Alley of the United States where about 8 tornados occur every 10,000 square miles each year. Also, the earthquake off the Pacific coast of Tohoku, Japan, with a subsequent tsunami devastated the area in March 2011. In 2015 we had fires that destroyed homes in California.

Current protection relies primarily on use of basements or interior rooms without windows. Tornado shelters, which are typically windowless shelters built into the ground, can be built on people's property or in conjunction with their house. Many of the current options involve improvements to entrances to shelters such as how they open and reducing the vertical components. Shelters of this type can be difficult or even unsafe to leave after a tornado depending on how the shelter opens and how debris has fallen. These shelters need to be stocked regularly with up to date food, water, and medical supplies. These shelters do nothing to protect property, except for items that individuals may bring with them. Due to the limited use, many of these do not have utilities such as lighting, running water, plumbing, or electricity. Furthermore, if the entrance to a shelter is outside of the house, people will need to risk going outside to reach the shelter

Some above ground shelters have been designed primarily to work with the wind patterns by having dome shaped buildings and reducing vertical sides. These structures do not allow for freedom of style in architecture, create issues regarding internal space, and most furniture is not designed with curved walls in mind, especially curved walls with a non-standard degree of curvature.

Tornados, Hurricanes, tsunamis along with other extreme weather scenarios are exceptionally dangerous to life, but they are also dangerous to real property, personal property, and items with sentimental value. Settling insurance claims can be a lengthy process while individuals are left without shelter.

### BRIEF SUMMARY OF EMBODIMENTS OF THE INVENTION

There is therefore a need for Extreme weather protection Shelters for home design that allows for maximal protection of lives and property.

The present invention relates to an Extreme weather protection shelter for home design that can be implemented with new homes, or potentially retrofitted for older homes.

In an embodiment of the invention, a home is above ground and can be retracted into the foundation which a portion of is above foundation during a tornado warning or any other extreme weather scenario such that the edge of the roof becomes flush with the upper foundation plate. A concrete structure with reinforced bars in walls and in the floor with a structural frame supporting the sub structure that the building is positioned on when retracted, is constructed around the building with a structural frame enclosed into an interior open volume sufficient for the building to be positioned onto. Dual metal sealed doors are located at each end of the foundation structure allowing vehicles and people to enter and exit. Additional vertical space is available for parking, depending on the embodiment, if the user intends to store controls or other elements beneath the building at all times. Within the foundation structure are telescopic jack assemblies that allow control the lowering and raising of the substructure and building. The substructure encompasses a shock isolation pad located outside and around the periphery and lock assemblies on each side that engage in tapered slots located on the side angle plates embedded around the periphery in the upper portion of the concrete foundation. Whereas the top surface of the substructure is flush with the top of the foundation. The lock assemblies are engaged and support the sub structure and building weight when the jack assembly power is turned off. Each lock assembly has an electric actuator that operates on 12 VDC. The lock assemblies are activated and operate in unison, while the jack assemblies support the weight of the substructure and the building. The Jack assemblies lift up the substructure relieving the load from the lock assembly pins. Thereafter, lowers the substructure down on the frame assembly and the power to the jacks are turned off. The lower structure also encompasses the jack controls, entry through Doors at each end of the foundation structure, lift platform or elevator, electrical controls, generator, waterlines, and sewer lines and provide stairway access to the house and provides an emergency exit on the roof.

The aforementioned staircase provides ingress and egress from the substructure. In a preferred embodiment it is a spiral, which can be purchased or designed. When the building is raised it provides access to the substructure. When the building is lowered around it, it provides access to an escape hatch. Surrounding the stairway may be a clear Plexiglas tube that is open below in two places.

Utility hookups can be designed to travel with the building structure.

A tornado or tsunami warning system may be included.

The present invention protects the structure of the building, the property inside, and the people. Also, people can remain safe while in the comfort of their home during a storm. Up to date food, water, and medical supplies are more likely to be in supply already. Electricity, running water, and plumbing will be available so long as it would be generally available. However, ion batteries could be used for a substitute and emergency water could be stowed in containers. Plumbing entering the building could have shut off valves, this would isolate contaminants coming into the building. Dangers from debris are also averted. Debris will not fall into an open door and the chance of being trapped is far less significant. If the building does need to remain retracted or lowered for any significant time period, not only will the people inside have access to the complete interior of their home, but it will be much easier for rescuers to see a lowered building than a covered shelter entrance.

When the building is retracted the sides of the exterior foundation and the roof are the portions exposed and are the portions that need to be configured to specifically withstand the winds and other weather events. The external foundation configuration and roof is shaped to allow turbulent wind traveling up to 300 mph to become laminar flow reducing the wind forces on the structure and the roof. Adding a 45 degrees wind deflector around the periphery located outside along the roof provides the wind a direction to go without causing any force loading on the edge of the roof when the house is retracted. In addition to prevent water from entering the structure there is a neoprene 30 durometer pad attached to the bottom and around the periphery of the roof that contacts the foundation plate when the house is retracted. There are pressure switches for each jack assembly located above the surface of the foundation plate and are activated when the roof makes contact which turns off the power to the Jacks. This differs from a typical above ground home structure that requires the entire surface area to be able to withstand the winds by combining heavy materials, exceptionally strong materials, and specially shaped materials. Although there are many options for the roofing materials, a recommended embodiment uses materials and designs similar to the exterior of an airplane. Therefore, even though the roof does not show any curvature, flat surfaces should be avoided.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is an isometric view of an extended embodiment of the invention with the interior visible.

FIG. 2 is an east elevation view of a retracted embodiment of the sloped roof and with the exterior foundation visible.

FIG. 3 is an isometric view of an extended embodiment of the invention with the interior visible.

FIG. 4 is an isometric view of a retracted embodiment of the invention with the interior visible.

FIG. 5 is an east side elevation view of an extended embodiment of the invention with the interior visible.

FIG. 6 is a west side elevation view of a retracted embodiment of the invention with the interior visible.

FIG. 7 is a south end view of an extended embodiment of the invention with the interior visible.

FIG. 8 is a south end elevation view of a retracted embodiment of the invention with the interior visible.

FIG. 9 is a top view showing emergency exits.

FIG. 10 is the interior bottom view showing the structural frame and various interior hardware.

FIG. 11 is a perspective view of the locking pin assembly.

FIG. 12 is a perspective view showing the locking pin features engaged into the foundation.

FIG. 13 is a breakaway view of supports and various items for the shelter, such as the wind deflectors, down spout outlets, shock isolation pad and embedded angle supports.

FIG. 14 is an interior view depicting the spiral stairway and the Plexiglas housing, the jack enclosures, lift platform, optional two stage jack assembly and stairway post embedded into concrete floor.

FIG. 15 is an isometric view of the door assembly and the structural frame assembly.

FIG. 16 is an interior isometric view of the door locking assembly.

FIG. 17 is an isometric view of the pressure switch assembly.

FIG. 18 is an east side elevation view.

FIG. 19 is an ISO structural frame assembly.

FIG. 20 is a diagram of a two stage electromagnetic jack assembly.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

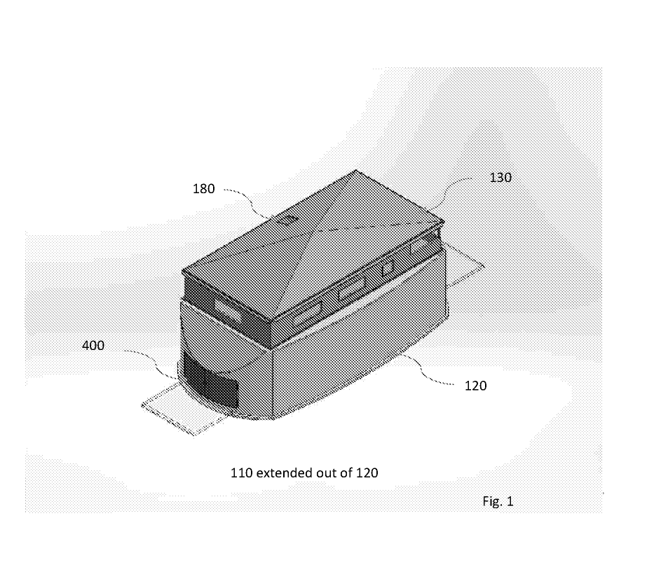

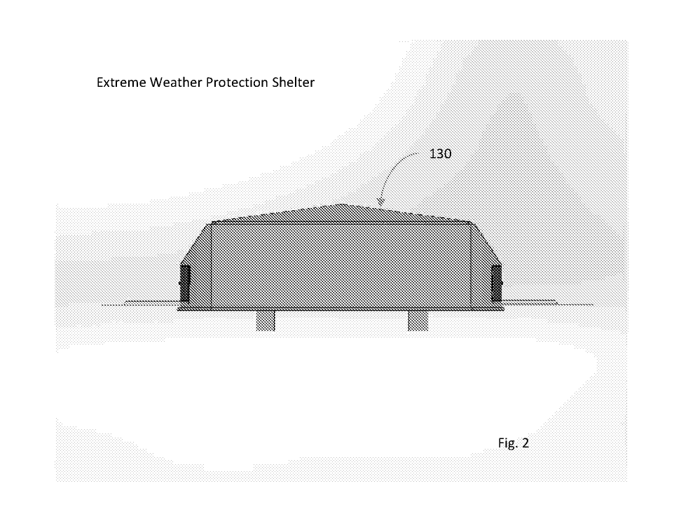

FIG. 1 is an isometric view of an extended embodiment of the invention with the exterior foundation visible and FIG. 2 is an east elevation view of a retracted embodiment of the slope roof and with the exterior foundation visible. Referring to FIG. 1, dual doors 400 are located at either end of the concrete structure 120, allowing for ingress and egress when the structure is retracted. FIGS. 1 and 2 show the raised building and concrete structure assembly 120. The building 110 has a roof 130 and the roof 130 in this embodiment is low and tapered. The roof 130 may have a conical shape. FIGS. 1 and 2 show an emergency exit hatch 180 located on the roof 130.

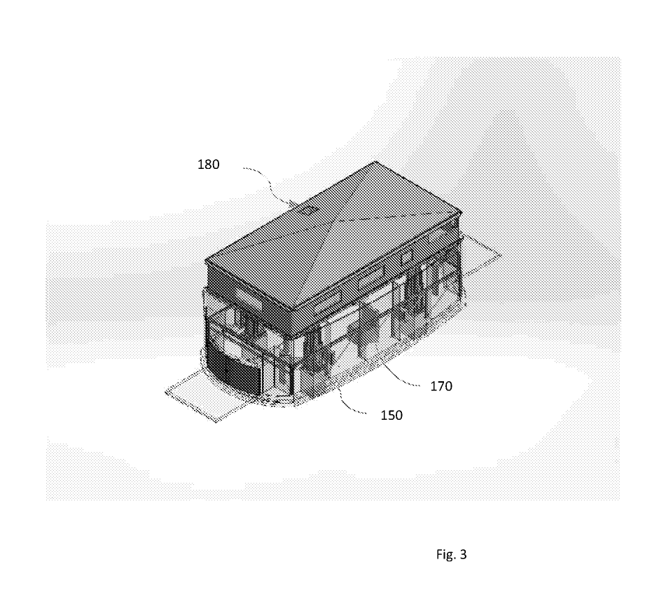

FIG. 3 is an isometric view of an extended embodiment of the invention with the interior visible. FIG. 3 shows the raised building and concrete structure assembly, as well as the emergency escape hatch 180 on the roof. FIG. 3 also shows four jack assemblies 150 that extend and retract the structure. Also visible in FIG. 3 is the elevator 170.

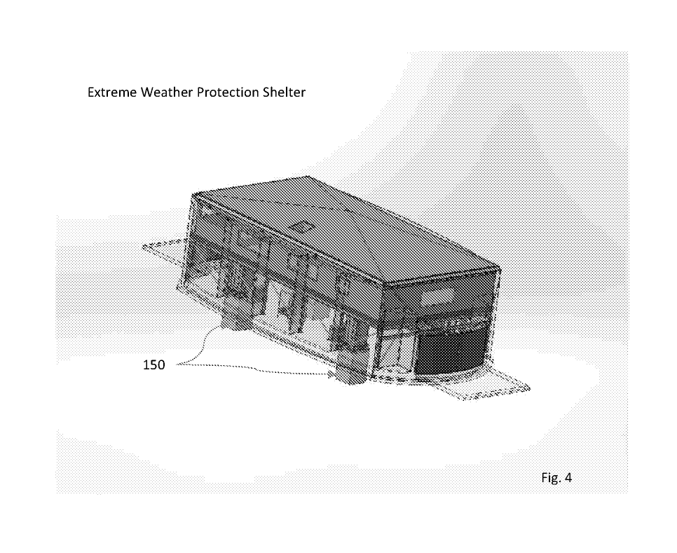

FIG. 4 is an isometric view of a retracted embodiment of the invention with the interior visible. FIG. 4 shows the jack assemblies 150 fully retracted so that the building has been lowered into the substructure, and no part of the building is exposed except the roof.

The substructure 120 has support walls 140 that in this embodiment are made of concrete. In the foundation structure 120 are the jack assemblies 150. In this embodiment the jack assemblies are telescopic and electromagnetic. The jack assemblies are capable of lifting up to 20 kips (20,000 lbs.) each in unison. They are also electrically driven limiting the need for hydraulic or pneumatic hardware to operate them. The electromagnetic drives operate by magnetic forces that are held in place when the electric current is turned on. The exact number of jack assemblies 150 will differ depending on the load of the building 110. Though not required, it is suggested that each jack assembly 150 have a rated capacity of two (2) times the working load.

Around the upper edge and below the leading edge of the roof of the foundation 120, and surrounding the building 110 when contacting the concrete surface is a wind deflector with a rubber/neoprene 30 durometer seal 220 bounded to the bottom surface that extends around the building. In this embodiment of the invention the building 110 has locking mechanism 190 attached to the inside and bottom portion of the concrete structure and located at each side and are positioned into the foundation plate spaced along the sides of the longest portion of the foundation. At each location where the locking pins engage through the shock isolation pad 305 that goes into the plate and foundation sub structure 120 are oval v-shaped openings which allow the building locking pins to rest into. This feature with the shock isolation pad will reduce damage to the structure during most earthquakes by allowing the lock assembly pins to fall back into position centering the home and sub-structure 120. It also has channels 162 that allows a user to travel via a spiral staircase 160 to the lower portion of the foundation structure 120. Inside the lower portion on the foundation structure are electric controls 200, jack controls 210, an emergency exit hatch 180 is located on the roof 130 for use via the spiral staircase 160 when the building 110 is retracted on top of the foundation 120.

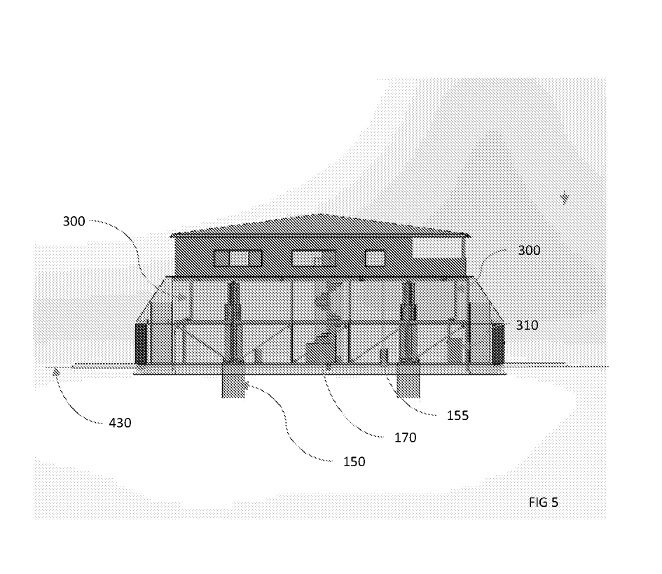

FIG. 3 and FIG. 5 are side views of an extended embodiment of the invention with the interior visible. In FIG. 5, the standard utility hookups 300 can be seen. In this embodiment a stand 310 is used to festoon the length of the hookups 300. Also shown are the jack assemblies 150, and the jack enclosures 155, and the elevator or platform 170. When the building 110 is lowered, the remaining length of the hookups 300 between the stand 310 and the building 110, will be lowered as well without the lower festoon remaining in place. In other embodiments reels or pulleys may be used. The standard hookups include fluid lines and can be connected to a septic system and pump.

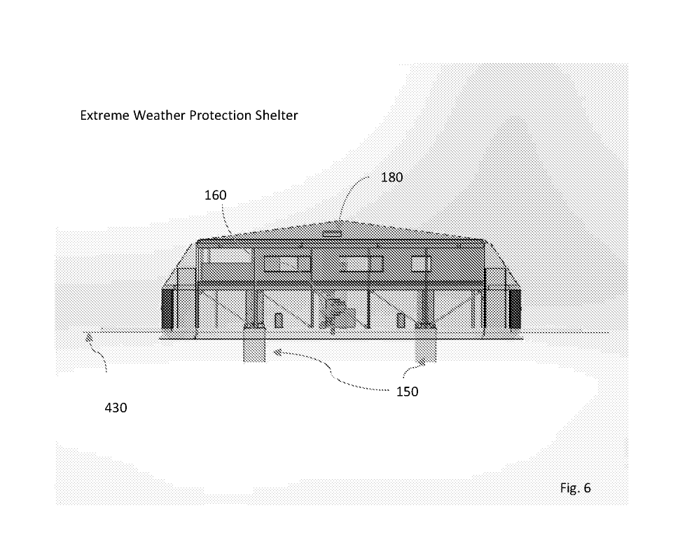

FIG. 6 is a front view of a retracted embodiment of the invention with the interior visible. This is an embodiment of the lowered building and substructure assembly 100. The jack assemblies 150 can be seen telescopically retracted. The roof 130 rests on the rubber seal 220 in the cavity 222 at ground 430 level. Also shown in FIG. 6 is the spiral staircase 160. A pipe located in the center of the stairway is used to attach the channels and extends into the concrete floor foundation.

An audio and visual warning system can be installed and connected to the weather bureau.

This embodiment also shows how the remaining space in the foundation structure 120 allows room for the retracted jack assemblies 150, a back-up generator 450, electric controls 200, jack controls 210, and lift platform 170 that extends through the sub structure into the building. The roof may house jack pressure switches 440 as a feedback mechanism. The load cells for the jack assemblies 150 are not visible, but are located within the jack assemblies 150 between the portions attached to the bottom of the substructure and the lower top plate of the jack assemblies 150.

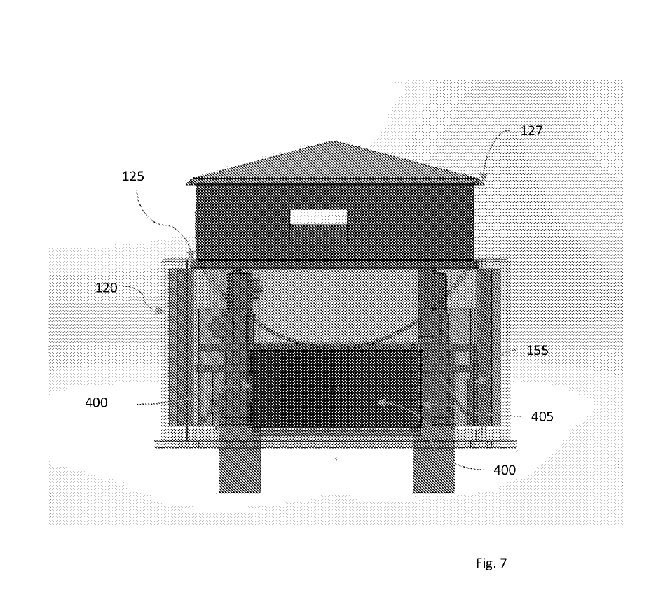

FIG. 7 is a south end elevation view of an extended embodiment of the invention with the interior visible. From this view, the dual doors 400 are visible, as well as the dual door hinges 405. The dual doors 400 have Neoprene seals located in the back of the doors and around the periphery of door frame. Also visible in FIG. 7 are the electrical jack enclosures 155 near the base of each jack assembly 150. Also shown in FIG. 7 is the concrete foundation 120, with a concrete foundation plate 125 embedded into the concrete foundation 120. A 45 degree extrusion with neoprene pad 127 is bonded to the underside of the roof 130 all around.

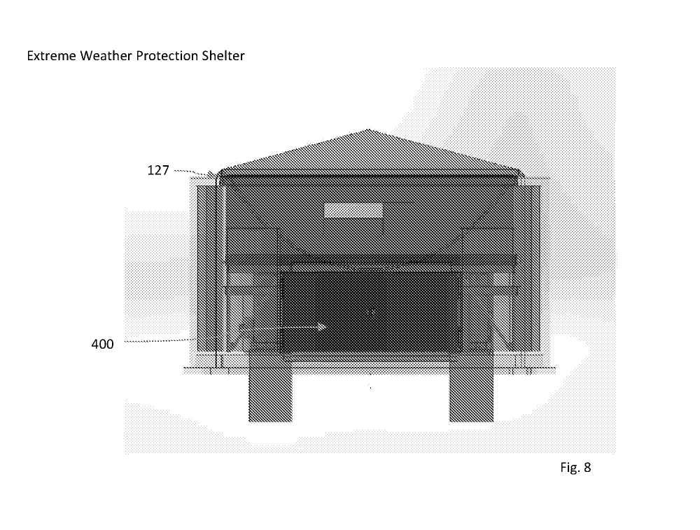

FIG. 8 is a south end elevation view of a retracted embodiment of the invention with the interior visible. Sealed dual doors 400 are provided, as well as the 45 degree extrusion with neoprene pads 127 bonded to the underside of the roof 130 all around.

Both FIGS. 7 and 8 illustrate the lowered building and foundation structure assembly 100. The jack assemblies 150 can be seen telescopically retracted. The roof 130 rests on the rubber seal 220. The dual seal doors, door hinges and door seals located at both north and south ends of the embodiment.

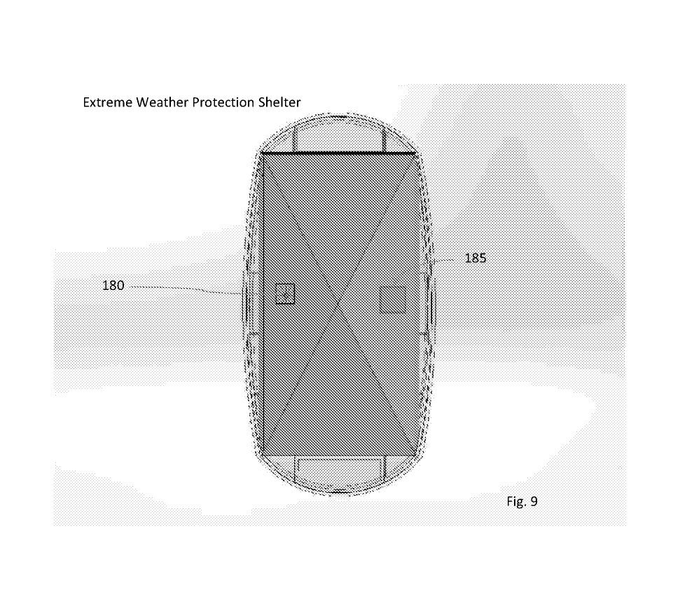

FIG. 9 is a top view showing the emergency exit 180 and the optional emergency exit using the elevator 185.

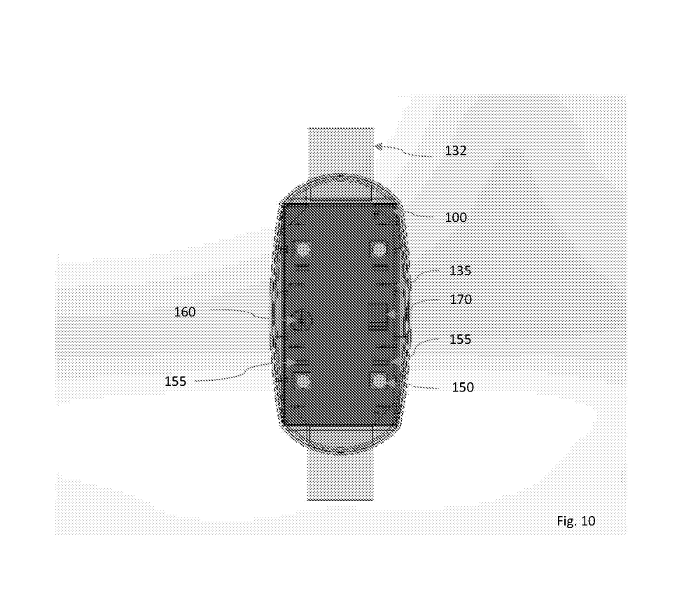

FIG. 10 is a bottom view depicting the outline of an embodiment 120, the structural frame and sub structure 100 and locking assemblies 135, stairway 160 and lift platform 170 locations. Also visible from this view are the jack drive enclosures 155 located next to each of the four jack assemblies 150. Also clearly shown are the foundation aprons 132 located at each end of the foundation.

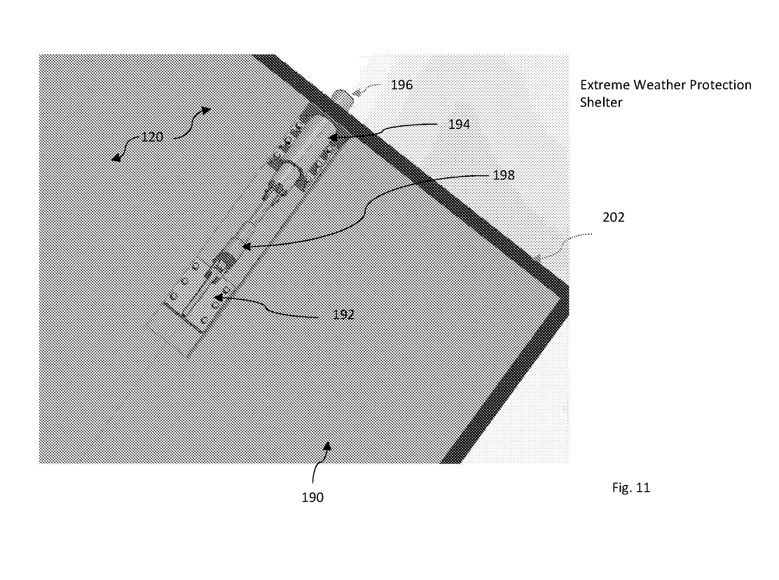

FIG. 11 depicts an isometric view of the locking pin assembly 190, locking pin actuator 198 and locking pin actuator mount 192, and the locking pin housing 194 all located on the substructure 120. From this view, the 4-inch diameter locking pin 196 can be seen extended out of the locking pin housing 194 and protruding out of the shock isolation pad 202 that lines the outer border of the substructure as it would when the locking mechanism is activated. The weight of the shock isolation pad 202 is determined by its location relative to the substructure 120. Four of the locking pin assemblies 190 as shown are required on each end of the substructure 120, so that the entire substructure 120 encompasses a total of eight locking pin assemblies 190.

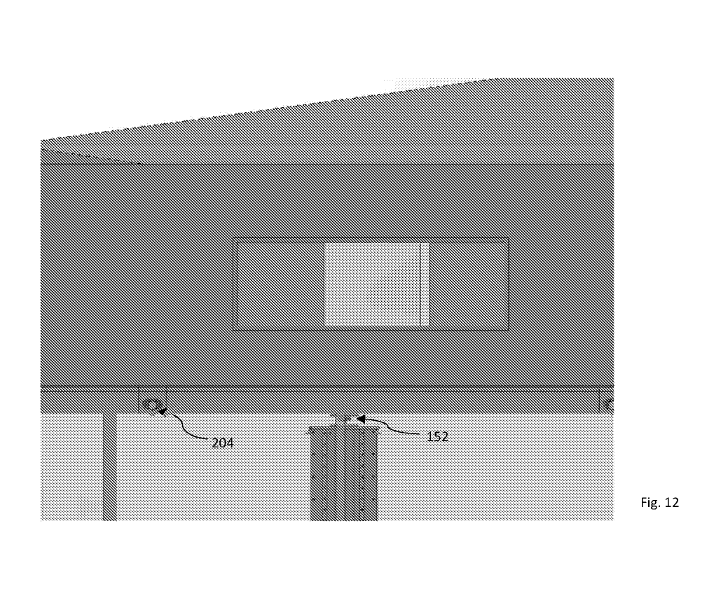

FIG. 12 depicts the locking pin tapered slots 204 located in the angle plate and embedded into the foundation 120. The locking pin tapered slots 204 taper downwards on both sides of the foundation 120. Also shown is one of the two-stage jack assemblies 150, as well as the two-stage jack swivel head 152 located at the top of the jack assembly 150 where it meets the angle plate. A pressure switch in this embodiment is mounted inside a threaded housing, which allows for adjustment. Tubing runs from the pressure switch to the jack assemblies 150. In this embodiment, the wiring runs through the concrete wall of the substructure 120.

A shock isolation system around and attached to the substructure 120 may be made of close cell foam blocks having a low density. The weight of the blocks will depend on the location site for earthquakes.

A one-story house has been used in these drawings, but the above ground structure could be any type of building or shelter.

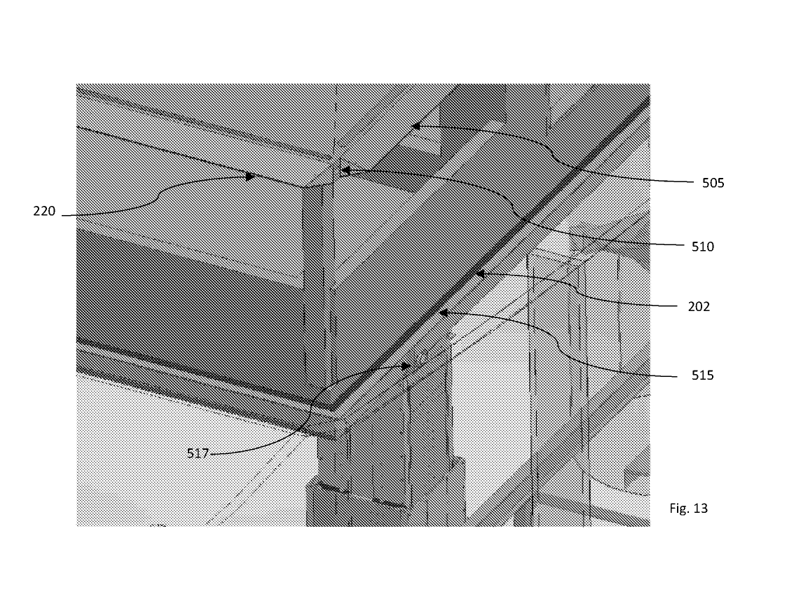

FIG. 13 is a breakaway view of supports and various items for the shelter. Such items include the roof wind deflectors 505, down spout outlets 510, shock isolation pad 202 and embedded angle supports 515. Also shown are the neoprene pads thirty Durometer 220 located on the underside of the roof wind deflectors 505. Also shown are angle supports 517 which are reinforced pads for engagement of the locking pin 196 and are distinct from the embedded angle supports 515.

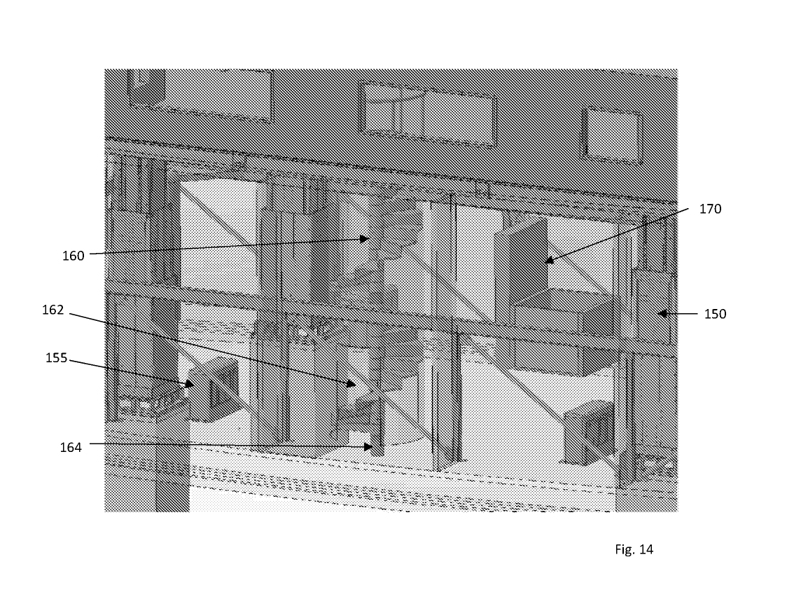

FIG. 14 is an interior view of an extended embodiment depicting the spiral stairway 160 and the Plexiglas housing 162, the jack enclosures 155, lift platform 170, optional two stage jack assembly 150 and stairway post 164 embedded into a concrete floor.

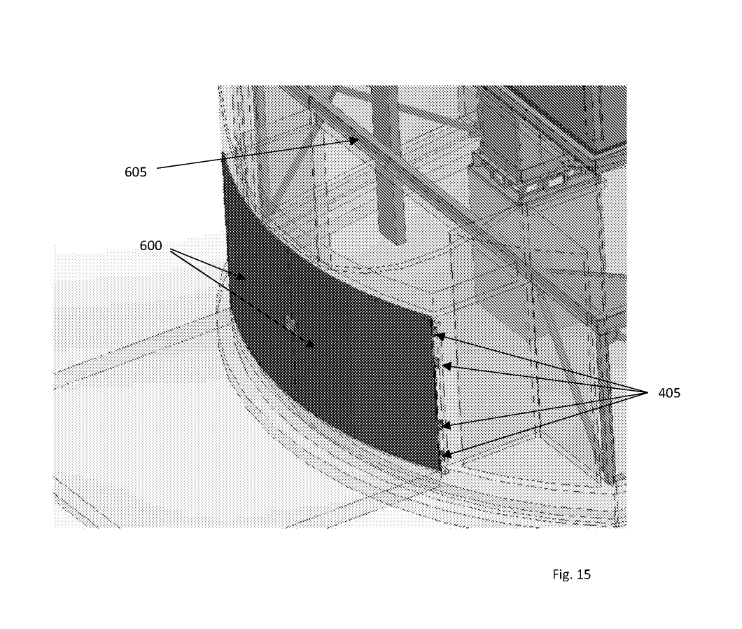

FIG. 15 is an isometric view of the door assembly 600 and the structural frame assembly 605. Visible in this view are the dual doors 400 and the door hinges 405.

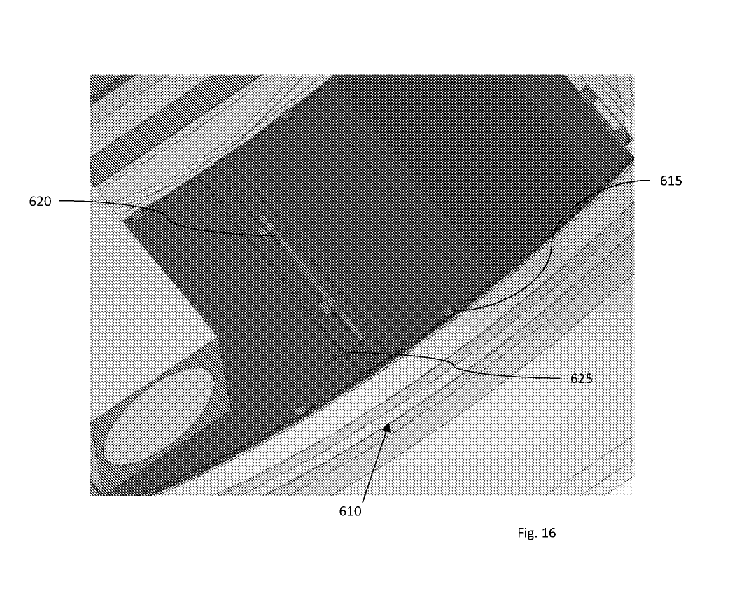

FIG. 16 is an interior isometric view of the door locking assembly 610. In this view, the dual doors 400 and the door hinges 405 can be seen from the interior of the structure. The door locking assembly 610 in FIG. 16 encompasses floor locks 615 which are located at the top and bottom of each of the dual doors 400. The door locking assembly 610 also comprises a bushing and housing 620 and a lock handle 625 which must be lifted upwards until the lock is no longer engaged and then rotated to unlock the doors.

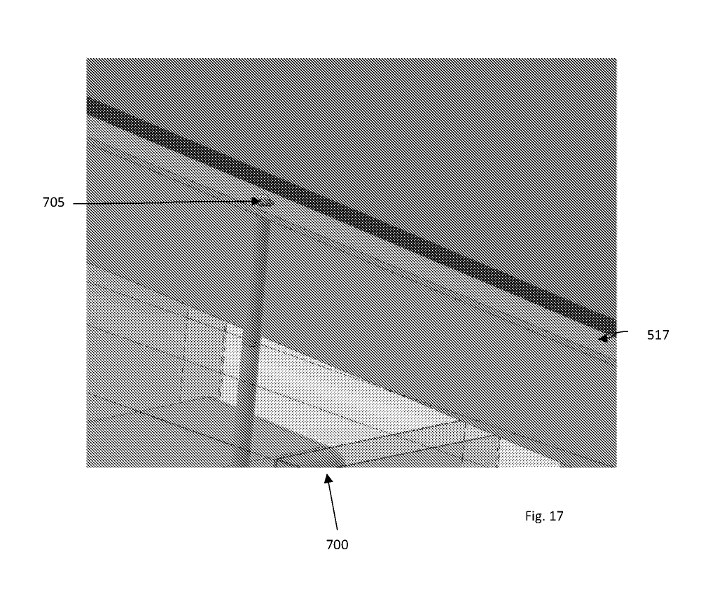

FIG. 17 is an isometric view of the pressure switch assembly 700. Visible in this view is a pressure switch 705 typical for each jack assembly 150, of which there are a total of four required. Also visible in this view is the structural angle support 517.

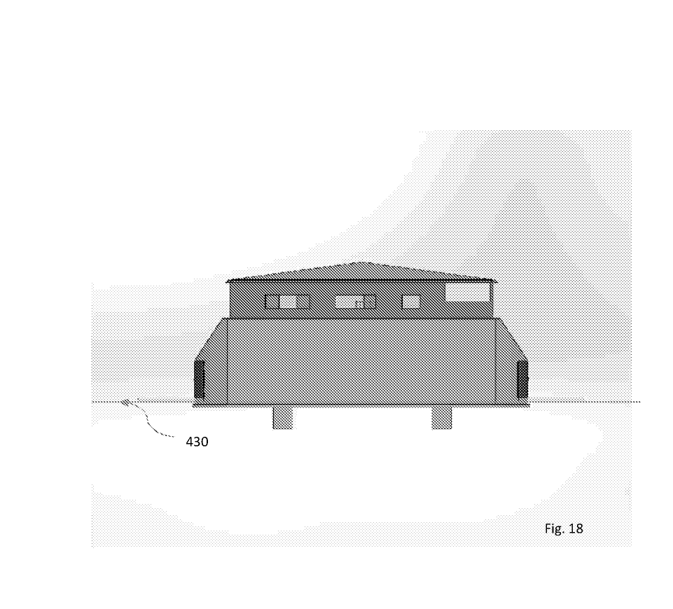

FIG. 18 is an east side elevation view depicting the building 110 extended out of the foundation structure 120.

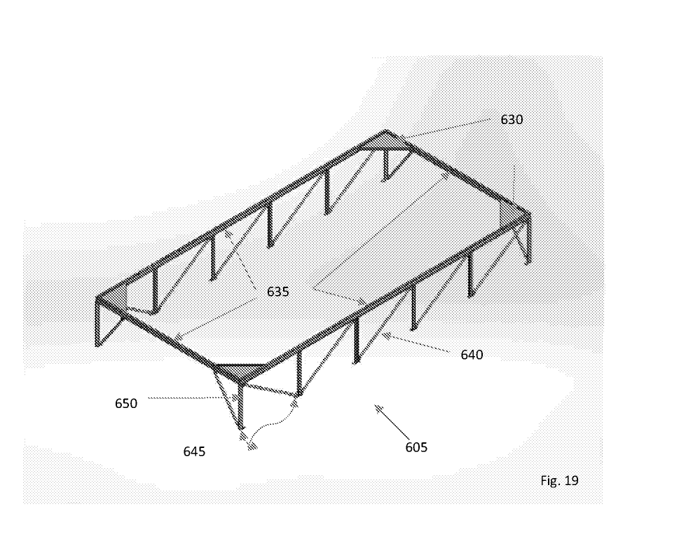

FIG. 19 is an isometric view of the structural frame assembly 605. Visible from this view are gussets 630 located in each corner of the structural frame assembly 605 and of which there are four total. Also visible in this view are the 12-inch I beams 635 that form the perimeter of the structural frame assembly 605. Connected to the 12-inch I beams 635 are 4-inch Posts 650 that connect to the 12-inch I beams 635 at their top and connect to concrete anchors with grouting 645 at their base. Diagonal bracing 640 runs from the concrete anchors 645 of the 4-inch posts 650 to the top of each subsequent 4-inch post 650, providing additional support for the structural frame assembly 605.

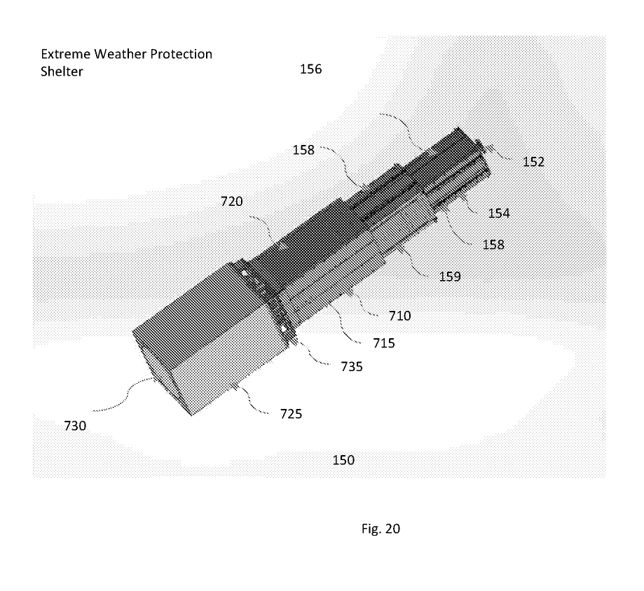

FIG. 20 is a diagram of a two stage electromagnetic jack assembly 150 extended telescopically to show each stage of the jack assembly 150. The two stage electromagnetic jack assembly depicted is rated for 10 tons with a 12-foot stroke. Visible at the top of the jack assembly 150 is the jack swivel head 152. Depicted directly beneath the jack swivel head 152 is the first stage assembly 154, which encompasses a scale with exposed linear encoder and positional feedback 156, and rails 158 that run the length of the first stage assembly 154. The scale 156 and rails 158 are also depicted in the second stage assembly 159, located directly beneath the first stage assembly 154. Depicted directly beneath the second stage assembly 159 is the primary housing assembly 710, which houses both the first stage assembly 154 and the second stage assembly 159 when the jack assembly 150 is telescopically retracted. The primary housing assembly 710 encompasses an outboard plate assembly 715 and a side plate assembly 720. At the very base of the two stage jack assembly 150 is the cable storage module 725, which comprises a PVC tube with bottom plate 730 at its bottom, and a jack support weldment with access openings 735 located at the area where the cable storage module 725 meets with the primary housing assembly 710. A two stage electromagnetic jack assembly may be found in U.S. Pat. No. 8,695,941, issued to Oliver Groves on Apr. 15, 2014, which is incorporated herein by reference in its entirety.

What is claimed is:

1. An above-ground extreme weather protection shelter for protecting homes, inhabitants of the homes, and the inhabitants' personal property within the home, from extreme weather conditions, including but not limited to hurricanes, tornadoes, floods, and fires, which uses jack assemblies to lower the home into the foundation of the protective shelter during extreme weather conditions, wherein:
the shelter is comprised of a concrete foundation structure into which the home can be retracted during an extreme weather scenario such that the edge of the roof of the home becomes flush with the upper foundation plate such that only the roof of the home and the external panels of the shelter are exposed to external elements, and wherein the shelter's exterior panels and the home's roof which are exposed when the home is retracted into the foundation are shaped to allow turbulent wind of up to 300 mph to become laminar flow thereby reducing the wind forces on the structure and the roof, and which roof may have added to it 45 degree wind deflectors around the roof's outside periphery so that strong winds will be redirected and the drag of the wind on the roof and structure will be minimized, and wherein, to prevent water or other elements from entering the structure during a storm, the roof contains a neoprene 30 durometer pad attached to the bottom and around the periphery of the roof that contacts the foundation plate when the house is retracted such that the area between the roof and the foundation plate is sealed off while the home is retracted,
and wherein the concrete foundation structure is constructed around the lateral exterior of the home with a structural frame enclosed into an interior open volume sufficient for the home to be positioned onto when retracted, which concrete foundation structure has reinforced bars in the walls and in the floor with a structural frame to ensure adequate support of the substructure on which the home is positioned when retracted,
and wherein the concrete foundation structure contains telescopic jack assemblies capable of extension and retraction that control the lowering and raising of the substructure and home into the foundation,
and wherein each telescopic jack assembly is accompanied by a jack drive enclosure located next to each telescopic jack assembly which powers the jack assemblies when activated,
and wherein the substructure on which the home is positioned when retracted encompasses a shock isolation pad located outside and around the periphery of the substructure to help reduce or eliminate damage or turbulence caused by extreme weather conditions,
and wherein the substructure also encompasses lock assemblies on each side of the substructure, each of which has an electric actuator that operates on 12 VDC, that engage in tapered slots located on the side angle plates embedded around the periphery of the substructure in the upper portion of the concrete foundation, and which lock assemblies are activated and engaged in unison and support the weight of the substructure and of the home when the jack assembly power is turned off, such that the lock assemblies support the home and substructure while the home is not retracted into the shelter,
and wherein, upon retraction of the home, the telescopic jack assemblies operate in conjunction with the lock assemblies such that the lock assemblies are activated and operate in unison while the jack assemblies support the weight of the substructure and the building, and such that the jack assemblies, when activated, lift up the substructure thereby relieving the load from the lock assembly pins, and thereafter the jack assemblies lower the substructure down onto the frame assembly at which point the power to the jack assemblies is turned off, and the home and substructure rest on the frame assembly,
and wherein each jack assembly has a corresponding pressure switch, located above the surface of the shelter's foundation plate, which are activated in unison when the roof of the home makes contact with the foundation plate when retraction is complete, such that the pressure switches turn off the power to the jack assemblies once retraction is complete so that the home rests completely on the frame assembly of the foundation when retracted,
and wherein the shelter is comprised of a lower structure beneath the concrete structural foundation which encompasses jack controls which control the jack assemblies and allow for controlled retraction or extension of the jack assemblies from the lower structure,
and wherein the lower structure also encompasses entry and exit ways through dual metal sealed doors located at each end of the foundation structure, which door sallow vehicles and people to enter and exit the shelter and the home safely from either side of the foundation structure while the home is retracted into the shelter foundation, and which doors are sealed with a neoprene pad located in the back of the doors in the interior of the shelter similar to the neoprene pads on the roof that allow for sealing to keep out water, wind, or other elements during extreme weather, and wherein the lower structure also encompasses a lift platform (elevator) and/or a stairway, which stairway is preferably a spiral but does not need to be, and which stairway can be purchased or designed according to the layout of the home, and which allow ingress and egress from the substructure when the home is raised, while the stairway provides access to an escape hatch when the home is retracted, which escape hatch is preferably located on the roof of the home where escape is most achievable when the home is retracted into the foundation, and which stairway may be surrounded by a clear Plexiglas tube open below in two places for entry and exit,
and wherein the lower structure also encompasses a generator to allow for power supply to the shelter and the home in the event other power sources are eliminated by extreme weather conditions, allowing for sustainable operation of the shelter for an extended period of time even without conventional power sources, and wherein the lower structure also encompasses festoon water lines which allow for alternative water supply to both the shelter and the home such that a reserved water supply is available to the inhabitants of the home while the home is retracted into the foundation during extreme weather conditions,
and wherein the lower structure also encompasses sewer lines such that plumbing and sewage disposal will also remain functional while the home is retracted into the foundation during extreme weather conditions.
